(19) United States
(12) Patent Application Publication
(10) Pub. No.: US 2004/0230644 A1
(43) Pub. Date: Nov. 18, 2004

(54) E-mail transfer server apparatus and e-mail transfer system

(76) Inventor: Tatsuo Aratake, Tokyo (JP)

Correspondence Address: SAMPSON & ASSOCIATES, P.C., 50 CONGRESS STREET, BOSTON, MA, 02109, US

(21) Appl. No.: 10/850,692

(22) Filed: May 21, 2004

Related U.S. Application Data
(63) Continuation of application No. PCT/JP01/10222, filed on Nov. 22, 2001.

(51) Int. Cl. G06F 15/16

(52) U.S. Cl. 709/201

(57) ABSTRACT

An E-mail directed to a mobile terminal is received, it is checked whether or not there is already designated information as to whether or not the e-mail is to be transferred, and the like as well as the capacity of the mail is measured. When the e-mail is to be transferred and the capacity thereof is within a predetermined range, the e-mail is transferred to the mobile terminal. Otherwise, the e-mail is not transferred or uploaded to another browsing server so that the e-mail can be browsed when it is accessed from the mobile terminal.

### RELATED APPLICATION

This application is a continuation of International Patent Application designating the U.S., Ser. No. PCT/JP01/10222, entitled E-Mail Transfer Server Apparatus And E-Mail Transfer System, which was filed on 22 Nov. 2001.

### TECHNICAL FIELD

The present invention relates to a technology for realizing a preferable transfer method in an e-mail transfer server apparatus and an e-mail transfer system for transferring mails to mobile terminals such as mobile phones and mobile computers.

### BACKGROUND ART

It has become possible that even ultra-small mobile phone terminals transmit and receive e-mails very easily due to widespread use of mobile phones and technological innovations. Further, mobile computers capable of transmitting and receiving mails by being connected to a mobile phone and a pay phone have been also become widespread, and many of the mobile computers can access not only to e-mail addresses but also to world wide web (WWW) addresses for displaying home pages of the URLs (uniform resource locators)of the Internet.

However, since communication fees of the mobile phone and the pay phones are very expensive as compared with those of ordinary phone lines and dedicated phone lines, it is very ineffective to receive unnecessary and unurgent e-mails. In particular, recently, direct mails called unsolicited mail which are transmitted to an indefinite number of e-mail addresses cause social problems, and a countermeasure for the problems is indispensable.

As a method for solving the problems, when a large number of mails having the same content are transmitted as well as almost all of a plurality of the addresses of the mails are invalid addresses, mobile phone communication operators impose a restriction so that the mails are not transmitted. In the above method, however, there is a possibility that this regulation is easily avoided by cheap tricks of transmitters, and further it cannot help being said that it is a problem for the mobile phone communication operators to intervene to the communications between customers from a view point of freedom of communications and privacy of communications.

Further, existing mobile terminals cannot cope with an e-mail which has an excessively large capacity as well as which is not necessary to be read at once in cosideration of its content although it is a necessary mail and with an e-mail which cannot be received by mobile terminals having a standard specification due to its capacity regardless of that it must be read urgently. Accordingly, the existing mobile terminals may not exert the usefulness thereof sufficiently.

### DISCLOSURE OF THE INVENTION

An object of the present invention, which was created in view of the above conventional background, is to provide an effectivee-mail transfer system capable of reliably transferring necessary e-mails to mobile terminals as well as suppressing a communication cost by not transferring unnecessary e-mails.

First, the present invention provides a transfer server apparatus for transferring a received e-mail to an e-mail address through which a mobile terminal receives the e-mail. The transfer server apparatus includes respective means described below and assures preferable transfer of e-mails. That is, the respective means are a mail receiving means, mail transfer means, designated information receiving means, designated information recording means, designated information check means, and transfer setting means.

An e-mail transmitted to the transfer server apparatus is received by the mail receiving means. Then, the designated information check means checks whether or not the newly received e-mail is an e-mail that corresponds to designated information based on the designated information recorded by the designated information recording means.

As a result of the check, the transfer setting means sets the e-mail so that it is transferred or not transferred from the mail transfer means according to the designated information, and when the mail is to be transferred, it is transferred from the mail transfer means.

In the above description, the designated information includes information relating to at least any one of whether or not it is necessary to transfer the e-mail next time and a method of transferring the e-mail.

Further, the transfer server apparatus of the present invention may be provided with a link addition means. The link addition means automatically adds a URL, which permits the designated information to be transmitted to the transfer server apparatus, to the e-mail to be transferred. At this time, the designated information receiving means receives the designated information after detecting that the mobile terminal accesses the URL.

The link addition means may embed a URL in the text of an e-mail, the URL designating not to transfer the e-mails transmitted from the same transmitter and the same transmission mail address subsequently to the e-mail.

Further, in the present invention, when a text, an attached file, and the like have a capacity larger than a certain length, it is possible to browse them by accessing from a mobile terminal without transferring them.

As a method for it, the transfer server apparatus includes upload means for uploading an e-mail to be transferred to a predetermined browsing server when the data length of the e-mail is longer than at least any one of a predetermined data length and a data length that can be received by a mobile terminal, and URL indicating mail transmission means for transmitting the URL of the browsing server through an e-mail.

In the above transfer server apparatus, the designated information, which is received from any one of a plurality of mobile terminals acting as subjects to which an e-mail is transferred, may be also used in the other mobile terminals as designated information.

With this arrangement, when a plurality of mobile terminals are owned by respective employees of a firm, the designated information recorded by one employee can be utilized by the other employees.

Further, the present invention provides an e-mail transfer system for transferring an e-mail received by the transfer server apparatus to a mobile terminal.

The e-mail transfer system is composed of a transfer server apparatus and a mobile terminal, and each of them has the following features.

First, the transfer server apparatus includes mail receiving means, mail transfer means, designated information receiving means, designated information recording means, designated information check means, and transfer setting means each having the above function.

In contrast, the mobile terminal includes a transferred mail receiving means for receiving a mail transferred by the mail transfer means and designated information transmitting means for transmitting the designated information as to the transferred mail.

Here, the e-mail transfer system may be an e-mail transfer system arranged such that the mobile terminal is a mobile phone terminal for executing radio communication and arranged to have an inherent e-mail address, and the mobile phone terminal can select whether or not it receives an e-mail according to the transmitter of the e-mail as well as can access the URL contained in the e-mail.

Further, in an arrangement that the mobile phone terminal permits to receive only a mail transferred from the transfer server apparatus, the mail transfer means of the transfer server apparatus may transfer an e-mail to the mobile phone terminal by a wake-on-ring when the e-mail is generated.

### BRIEF DESCRIPTION OF THE DRAWINGS

FIG. 1 is a schematic view of an e-mail transfer system according to the present invention;

FIG. 2 is a view of an arrangement of an e-mail transfer server apparatus according to the present invention;

FIG. 3 is a view explaining a transfer rejection database according to the present invention;

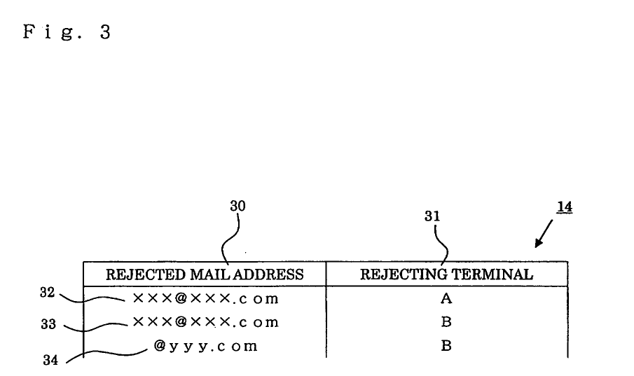

FIG. 4 shows the contents of a transferred mail when the capacity of the transferred mail exceeds a predetermined capacity;

FIG. 5 shows the contents of a transferred mail when a tag attachment function according to the present invention is not used;

FIG. 6 shows the contents of a transferred e-mail when the tag attachment function according to the present invention is used;

FIG. 7 shows the contents of a mail summary for notifying a list of mails that are not transferred according to the present invention; and

FIG. 8 is a flowchart of processing of the e-mail transfer server apparatus according to the present invention.

Reference numerals indicate the following sections.

1: mail format automatic shaping unit according to the present invention

2: mail client on transmitter side

3: SMTP server

4: POP server

5: the Internet or Intranet

6: mail client on a receiver side

### BEST MODE FOR CARRYING OUT THE INVENTION

An embodiment of the present invention will be described below based on an example shown in the drawings. It should be noted that the embodiment can be appropriately modified as long as it does not depart from the gist of the present invention.

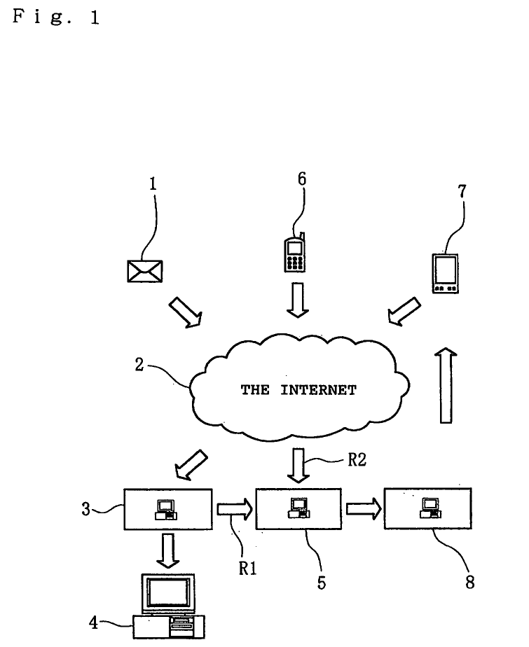

FIG. 1 is a view showing an outline of an e-mail transfer system according to the present invention. What is called a mobile terminal in the present invention includes a mobile phone terminal and a mobile computer. A computer, which is classified particularly into a PDA (personal digital assistance) is assumed as the mobile computer, the main function of the PDA being a schedule management, connection to the Internet such as transmission, reception, and the like of address files and mails.

E-mails transmitted from a transmitter (1) through the Internet (2) are received by a mail receiving server (3) disposed conventionally. Ordinarily, accumulated e-mails are read by a mail receiving client (4) which is composed of a personal computer, and the like and accesses the mail receiving server (3).

An e-mail transfer system according to the present invention further includes an e-mail transfer server (hereinafter, simply referred to as “transfer server”) (5) which transfers an e-mail to a mobile phone (6) and a PDA (7). The transfer server (5) may be provided with a route (R1) through which a mail is retransmitted thereto as soon as it is received by the mail receiving server (3) or with a route (R2) through which the transfer server (5) directly receives a mail from the Internet (2).

Further, since the mail receiving server (3) and the transfer server (5) include portions having the same function, they may be substantially arranged as a single device having the functions of both the servers (3) and (5).

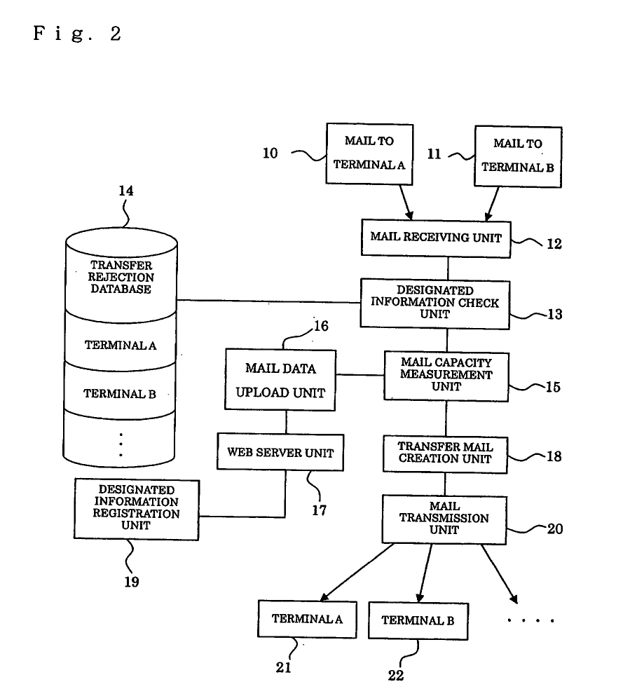

FIG. 2 is a view showing an arrangement of the transfer server (5). Mails (10) and (11) transmitted through the Internet (2) (or through the mail receiving server (3) depending on an arrangement) are received by a mail receiving unit (12). The mail receiving unit (12) has a function for receiving all the mails transmitted to, for example, a certain domain, and, in the case of the figure, the mail receiving unit (12) receives all the mails transmitted to terminals A (10), B (11) and so on of the same domain.

The received e-mails are checked by a designated information check unit (13) whether or not they are a type of e-mails to which any designated information is added.

Here, an external memory device is connected to the designated information check unit (13), and a transfer rejection database (14) is stored in the external memory device. FIG. 13 shows an example of the transfer rejection database (14).

Data accommodated is a correspondence table between transfer rejected mail addresses (30) and transfer rejecting mobile terminals (31), and it is shown that an e-mail whose transmitter is, for example, xxx@xxx.com is rejected by both of A (32) and B (33), and an e-mail transmitted from a domain yyy.com is rejected by B (34). yyy.com is rejected by B (34).

In the e-mail transfer system of the present invention, a mail the transfer of which is rejected is not transferred and it is processed in the transfer server (5). However, the mail is accumulated in the mail receiving server (3), it can be ordinarily read when it is read out from the mail receiving client (4).

When it is found that transfer of the received mail is not rejected as a result of check executed by the designated information check unit (13), the mail is processed in a mail capacity measuring unit (15) which examines the capacity of the mail.

The mail capacity measuring unit (15) measures the capacity of the mail to confirm whether or not the capacity of the mail conforms to the mail receiving capacity of the mobile phone (6) and the PDA (7). For example, the capacity of the ordinary mobile phone (6) is limited to 250 characters in a full size, and the like, and a mail having a number of characters larger than 250 characters is interrupted halfway of reception. Accordingly, when the mail is transmitted without measuring the capacity thereof, the contents of the mail cannot be sufficiently confirmed, and a mail transfer function cannot be accomplished.

To cope with the above problem, a mail, which is determined to have, for example, 250 characters or more or data amount of, for example, 100 KB or more in the mail capacity measurement unit (15), is uploaded to a WEB server unit (17) disposed in the transfer server (5) through a mail data upload unit (16).

The mail data upload unit (16) uploads the data of the e-mail exceeding the above capacity to a URL which is regularly generated in the WEB server unit (17) so that the mail can be read out from a terminal by connecting it to the Internet (2) and accessing the URL thereby.

With the above arrangement, even the mobile phone (6) and the PDA (7) whose mail capacity is limited can reliably read out all the text of a mail by making access using, for example, a WWW browser. Further, although the mobile phone (6) and the like cannot read out an attached image file in many cases, they can read a map and the like even if they are attached to an e-mail without a problem using the transfer server (5).

Further, this function can be also used to suppress a communication cost, in addition to the case of a-mail exceeding the capacity. That is, it is possible not to tranfer a mail regardless of the capacity of the mobile phone (6) and the like when the capacity of the mail measured by the mail capacity measuring unit (15) exceeds a capacity previously determined separately, for example, 15 KB.

In this case, since the existence of the mail is notified by processing described later, it can be read by accessing the above URL when it is necessary to read it in consideration of information such as a transmitter's name and the like. With this arrangement, it is not necessary to readout a long wasteful mail, which contributes to reduction of a communication cost.

The WEB server unit (17) can be accessed from anywhere because it constitutes a WEB server connected to the Internet at all times and has a fixed IP address and domain name. However, the WEB server unit (17) has a problem in confidentiality as it is, it is necessary to individually authenticate terminals that access the WEB server unit (17) or to authenticate the terminals by passwords and the like. Further, confidentiality can be enhanced by combining the present invention with a wake-on-ring technology. This technology will be described later.

After the completion of the processing steps described above, the contents of a mail to be transferred are created by a transfer mail creation unit (18). In the present invention, the following two characteristic processing steps will be mainly executed.

That is, one of the processing steps is to create a mail for notifying that a mail exceeding the capacity arrives by adding the above URL, and the other of the processing steps is to create a mail to which a designation method for rejecting subsequent transfer is applied.

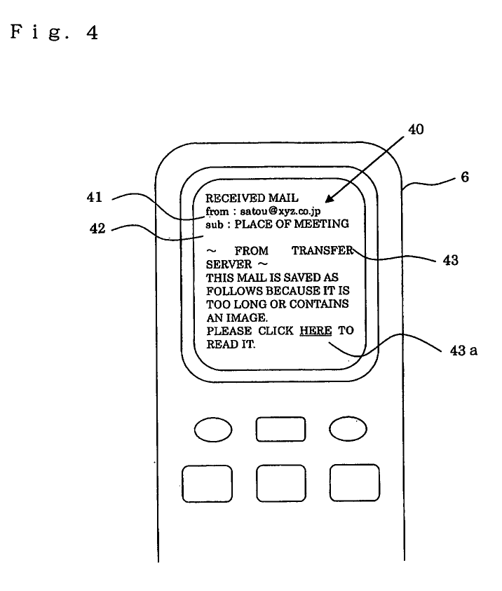

First, the former mail will be described. FIG. 4 shows a mail (40) created by the transfer mail creation unit (18) when a long mail arrives. As described above, the transfer server (5) transfers a sender's name in a FROM column (41) and a subject in a subject column (42) as they are shown in an original e-mail transmitted thereto and describes a message created by the transfer server (5) in a text column (43).

It is shown here that the mail cannot be transferred as it is because it contains a long message exceeding the predetermined capacity or a file attached to the mail includes an image, and it is possible to access a URL from which the original e-mail can be read out by pointing at a term “here” (43a) through the mobile phone (6).

The term “here” (43a) uses a tag of html and permits the mobile phone (6) to be linked to the URL that is automatically generated in the WEB server unit (17).

As described above, since the original e-mail can be easily read out even from the mobile phone (6) and the PDA (7) by the very easy arrangement also in the transfer server (5), a conventional problem that a whole text and an image cannot be read out can be solved.

A certain degree of the contents of the original e-mail may be described in a mail text (43) so that the outline of a theme can be found. Further, the original e-mail may be summarized using a language processing technology so that a summary thereof can be transferred. Further, a reduced image (thumb nail) may be created and transferred to a mobile phone, PDA and the like, which they can receive an image.

Another function of the transfer mail creation unit is to add a URL so that refusal of transfer can be easily designated.

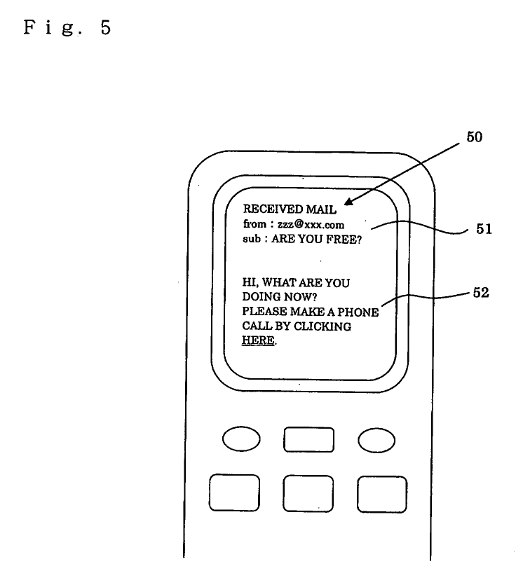

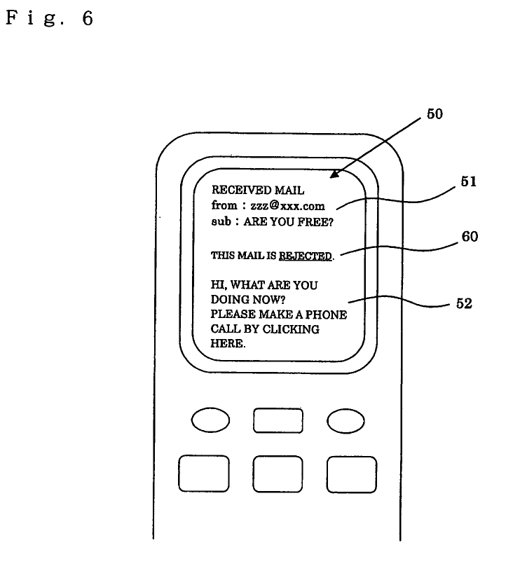

FIG. 5 is a view showing a transferred mail when this function is not used, and FIG. 6 is a view showing a mail to which a link to the URL is added by this function.

The transfer server (5) includes the transfer rejection database (14) as described above and can effectively prevent transfer of unnecessary mails (in particular, junk mails such as direct mails). However, a junk mail (50) as shown in the figure may be rarely transferred depending on setting.

The transfer server (5) according to the present invention can simply register the address of the transmitter of the e-mail to the transfer rejection database (14) so that subsequent transfer is not executed.

When, for example, the junk mail (50) is received from an address zzz@xxx.com (51) which is not registered in the transfer rejection database (14), an html tag (60) describing that “this mail is rejected” is added to the text (52) of the mail as shown in FIG. 6, and the transfer server (5) registers a transmitter's address (51) to the transfer rejection database (14) by accessing a URL corresponding to the tag.

In an actual operation, the transfer mail creation unit (18) mechanically adds the tag (60) to a mail to be transferred, the tag is arranged to access the WEB server unit (17) as well as when the WEB server unit (17) is accessed, the mail is transmitted together with the transmitter's address (51) added to its URL.

When the WEB server unit (17) is accessed, a designated information registration unit (19) fetches the transmitter's address (51) and the mobile phone (6), from which the WEB server unit (17) is accessed, from the access information and registers them in the transfer rejection database (14).

According to this function, as for an unnecessary mail (junk mail) transferred by mistake, the mobile phone indicates the tag (60) “for rejecting the mail” with the result that the information of the transmitter of the junk mail and the mobile phone (6) that rejected the junk mail is automatically transmitted, and subsequent junk mails can be effectively prevented.

With the above arrangement, the contents of the transfer mail created by the transfer mail creation unit (18) is transferred from a mail transmission unit (20) to respective intrinsic terminals (21) and (22).

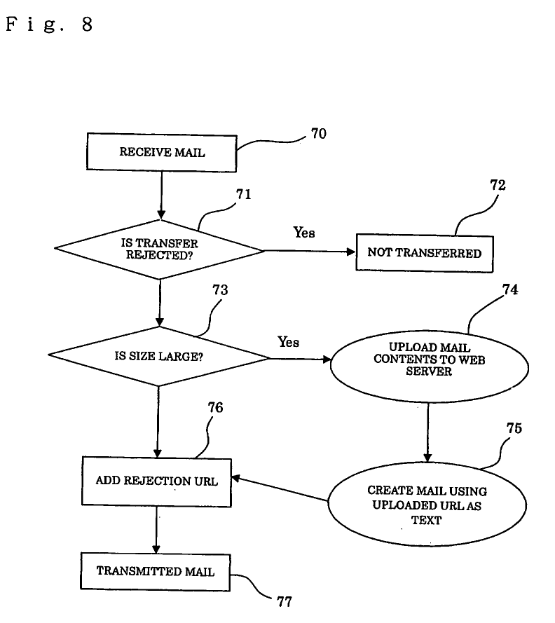

The transfer server (5) according to the present invention is arranged as described above, and FIG. 8 shows a flowchart of processing executed by the transfer server (5) when it transfers a mail.

First, when the mail is received (70), it is determined whether or not transfer of the mail is rejected (71), and when it is rejected, the mail is not transferred (72).

Next, it is determined whether or not a capacity is larger than a predetermined size (73), and when the capacity is larger than the predetermined size, the contents of the mail are uploaded to the WEB server (74) as well as a mail in which an uploaded URL is described in a text is created (75).

When the capacity of the mail is not larger than the predetermined size, the mail is transferred as it is (77) together with a URL capable of rejecting next transfer added to a text.

Although this embodiment may be arbitrarily modified, particularly effective modifications will be described below in detail.

First, although the designated information check unit (13) checks only the rejection of transfer as to the designated information in this embodiment, a transfer server, which can comply with a higher level of requirements can be assurred by changing the contents of the database.

For example, it is possible to classify mails into mails the transfer of which is rejected, mails only the themes of which are transferred, and mails the entire texts of which are transferred according to the addresses of transmitters. In the case of transferring only the themes, it is contemplated to transfer a list of themes when, for example, five mails only the themes of which are transferred are stored.

Further, in this embodiment, it is possible for the mail transmission unit (20) to transmit a list of mails which are not transferred to the mobile phone (6) and the PDA (7) because the transfer thereof is rejected by the designated information.

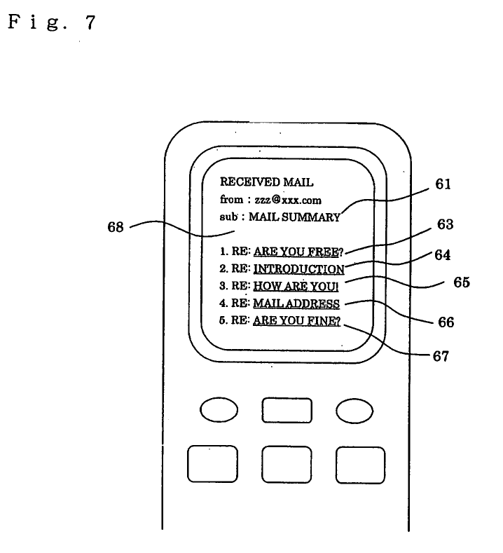

That is, transfer-rejected mails can be restored and browsed in such a manner that when a certain number of the transfer-rejected mails are accumulated, the themes and the partial texts thereof are transferred in a single mail together with a URL similar to that described above which permits the entire texts of the transfer-rejected mails to be browsed. FIG. 7 shows an example of the mail transmitted at the time.

As shown in the figure, when, for example, five transfer-rejected mails are accumulated, a list of the themes (63 to 67) of the respective mails are given in a mail (61) called a mail summary (62) as well as the respective mails are uploaded from the mail data upload unit (16) to the WEB server unit (17), and the URLs thereof are linked to the themes.

With the above arrangement, when, for example, transfer of a mail is rejected because the mail address of a transmitter is changed, the entire text of the mail can be browsed by indicating a mail (66) that notifies this fact, thereby there does not happen a case in which an important mail is not read.

Further, a restoration link (68) for designating transfer of subsequent mails may be provided in addition to the link so that data registered from the designated information registration unit (19) to the transfer rejection database (14) is cancelled by designating the restoration link (68). With this operation, mails can be transferred as necessary, thereby permission of real time transfer can be assurred.

Further, when mail data is uploaded according to the capacity of a mail measured by the mail capacity measuring unit (15), whether or not the mail data is to be uploaded can be individually changed according to a type of the mobile phone (6) and the PDA (7) and a standard of communication firms and the like. In this case, a capacity data base is provided additionally according to mobile terminals, and mail data is uploaded based on a different criterion such that a mail having 250 characters or more is uploaded in the mobile phone of a communication firm A, a mail having 5000 characters or more is uploaded in the mobile phone of a communication firm B, and an image is transmitted as it is in a C type PDA.

With this arrangement, e-mails can be transferred individually depending on various types of mobile terminals.

Further, in the embodiment of the present invention, it is possible to upload an e-mail to the WEB server and the like according to a data format included in the e-mail, in addition to the mail capacity.

For example, it is possible to upload an image regardless of its capacity and to transfer a mail including audio data that cannot be reproduced by a mobile phone after the audio data is removed.

Further, the transfer server (5) may be provided with a wake-on-ring server (8).

A wake-on-ring technology is such a technology that when data to be distributed is generated in a server and the server notifies a type of the data and the generation thereof to a terminal by calling it, an appropriate application is automatically started in the terminal and the terminal is connected to the server and reads out the data.

The wake-on-ring technology is most suitable to deliver data to the mobile terminal because the data is not distributed unilaterally to ensure the reliable distribution thereof as well as the data is distributed immediately.

Accordingly, this technology is employed also in the e-mail transfer system according to the present invention, and when an e-mail to be transferred is generated in the transfer server (5), data is transmitted to the wake-on-ring server (8), and the PDA (7) corresponding to the wake-on-ring is called.

In the PDA (7), e-mail client software is started and requests the transfer server (5) to read the mail, and the mail is transmitted from the mail transmission unit (20) of the transfer server (5).

Since connection to the mail transmission unit (20) is executed from the PDA (7) different from the above arrangement that the mail is transmitted unilaterally from the mail transmission unit (20), a mail can be reliably transmitted to the PDA (7).

Note that the processing executed in the transfer server (5) is the same as that of the above embodiment except the operation mode of the mail transmission unit (20).

In the embodiment of the present invention, when a mobile terminal has an inherent address, the mobile terminal may be arranged to reject reception of all the mails except the mails transferred from the transfer server (5) so that the mobile terminal receives all the mails through the transfer server (5).

With this arrangement, it is impossible to directly send a junk mail to the mobile terminal, and thereby it is definitely passed through a filter provided in the transfer server (5). The transfer server (5) stores only mail addresses, which permit to transfer mails thereto, in a database and does not transfer e-mails other than previously permitted ones.

With this arrangement, all the junk mails are not transferred and necessary mail can be transferred by previously registering the domains of trading partner firms and the like.

Further, it is possible for a plurality of terminals to share the transfer rejection database and the database, in which the designated information is recorded, such as the database of the mail addresses to which mails are to be transferred. That is, an e-mail address, which is rejected by a mobile terminal, may be registered in the designated information registration unit (19) and the like so that the e-mail address is rejected by all the terminals.

Industrial Applicability

According to the present invention, the above arrangement enables to selectively transfer mails transmitted to the users of respective mobile terminals, thereby a less expansive e-mail transfer system can be provided without sacrificing the usefulness of the mobile terminals.

Further, even if an unnecessary mail is transferred, since a designation method for designating a subsequent transfer method can be provided with the mail, it is possible for a mobile terminal to easily set whether or not transfer is necessary and a transfer method.

Further, since the e-mail transfer server system according to the present invention can be attached to an existing mail system, it is not necessary to reconstruct a new system so that an effective e-mail transfer system can be assurred at low cost.

1. A transfer server apparatus for transferring a received e-mail to an e-mail address through which the e-mail is received by a mobile terminal, characterized by comprising:
mail receiving means for receiving the e-mail;
mail transfer means for transferring the e-mail to the mobile terminal;
designated information receiving means for receiving designated information, which relates to at least any one of whether or not it is necessary to transfer the e-mail next time and a method for transferring the e-mail, from the mobile terminal;
designated information recording means for recording the designate information;
designated information check means for checking whether or not a newly received e-mail is an e-mail corresponding to the designated information; and
transfer setting means for setting, when the newly received e-mail corresponds to the designated information, the e-mail so that it is transferred or not transfer from the mail transfer means according to the designated information.

2. A transfer server apparatus according to claim 1, characterized by comprising:
link addition means for automatically adding a URL, which permits the designated information to be transmitted to the transfer server apparatus, to the e-mail to be transferred,
wherein the designated information receiving means receives the designated information after detecting that the mobile terminal accesses the URL.

3. A transfer server apparatus according to claim 2, wherein the link addition means embeds a URL in the text of an e-mail, the URL designating not to transfer the e-mails transmitted from the same transmitter and the same transmission mail address subsequently to the e-mail.

4. A transfer server apparatus according to claims 1 to 3, characterized by comprising:
upload means for uploading the e-mail to a predetermined browsing server when the data length of the e-mail to be transferred is longer than at least any one of a predetermined data length and a data length that can be received by a mobile terminal; and
URL indicating mail transmission means for transmitting the URL of the browsing server to the mobile terminal through an e-mail.

5. A transfer server apparatus according to claim 3, characterized by comprising
upload means for uploading not-transferred e-mails, which are not transferred in response to the designated information, to a predetermined browsing server when the not-transferred e-mails exceed a predetermined number, wherein the mail transfer means transmits a summary mail, in which at least any ones of the themes of the not-transferred e-mails, at least parts of the texts thereof, and the summaries of the texts thereof are described as a list to which the URL of the not-transferred e-mails on the browsing server is added, to the mobile terminal.

6. A transfer server apparatus according to claim 1, wherein the mail transfer means of the transfer server apparatus transfers an e-mail to the mobile terminal by a wake-on-ring.

7. A transfer server apparatus according to claim 1, wherein the designated information, which is received from any one of a plurality of mobile terminals acting as subjects to which an e-mail is transferred, is also used in the other mobile terminals as designated information.

8. An e-mail transfer system for transferring an e-mail received by a transfer server apparatus to a mobile terminal, characterized in that the transfer server apparatus comprises mail receiving means for receiving the e-mail, mail transfer means for transferring the e-mail to the mobile terminal, designated information receiving means for receiving designated information, which relates to at least any one of whether or not it is necessary to transfer the e-mail next time and a method for transferring the e-mail, from the mobile terminal, designated information recording means for recording the designate information, designated information check means for checking whether or not a newly received e-mail is an e-mail corresponding to the designated information, and transfer setting means for setting, when the newly received e-mail corresponds to the designated information, the e-mail so that it is transferred or not transferred from the mail transfer means according to the designated information, and
the mobile terminal comprises transferred mail receiving means for receiving a mail transferred by the mail transfer means and designated information transmitting means for transmitting the designated information as to the transferred mail.

9. An e-mail transfer system according to claim 8, wherein the mobile terminal is a mobile phone terminal for executing a radio communication and arranged to have an inherent e-mail address, and the mobile phone terminal can select whether or not it receives an e-mail according to the transmitter of the e-mail as well as can access the URL contained in the e-mail.

10. An e-mail transfer system according to claim 9, wherein, in an arrangement that the mobile phone terminal permits to receive only a mail transferred from the transfer server apparatus, the mail transfer means-of the transfer server apparatus transfers an e-mail to the mobile phone terminal by a wake-on-ring when the e-mail to be transferred is generated.

11. (New) A transfer server apparatus according to claims 1 to 3, comprising:
upload means for uploading when the data length of an e-mail to be transferred is longer than at least any one of a predetermined data length and a data length that can be received by a mobile terminal, the e-mail to a predetermined browsing server; and
URL indicating mail transmission means for transmitting an e-mail, to which the URL of the browsing server is added, to the mobile terminal together with any one of a portion of the e-mail having a predetermined data length, a portion of the e-mail having a capacity previously determined separately, and the summary of the contents of the text of the e-mail.

12. A transfer server apparatus according to claims 1 to 3, comprising:
upload means for uploading, when an e-mail to be transferred includes image data, the e-mail to a predetermined browsing server; and
URL indicating mail transmission means for transmitting an e-mail, to which the URL of the browsing server is added, to the mobile terminal together with an image whose size is reduced to a predetermined image size or less.

13. An e-mail transfer system according to claim 9,
characterized in that the transfer server apparatus comprises link addition means for automatically adding a URL, which permits the designated information to be transmitted to the transfer server apparatus, to an e-mail to be transferred.
wherein the designated information receiving means receives designated information by detecting that the URL is accessed by the mobile terminal.

14. An e-mail transfer system according to claim 13, wherein
the link addition means embeds a URL in the text of an e-mail, the URL designating not to transfer the e-mails transmitted from the same transmitter and the same transmission mail address subsequently to the e-mail.

15. An e-mail transfer system according to claim 13 or 14, wherein
the transfer server apparatus comprises:
upload means for uploading, when the data length of an e-mail to be transferred is longer than at least one of a predetermined data length and a data length that can be received by a mobile terminal, the e-mail to a predetermined browsing server; and
a URL indicating mail transmission means for transmitting the URL of the browsing server to the mobile terminal through an e-mail.

16. An e-mail transfer system according to claim 13 or 14, wherein
the transfer server apparatus comprises:
upload means for uploading, when the data length of an e-mail to be transferred is longer than at least one of a predetermined data length and a data length that can be received by a mobile terminal, the e-mail to a predetermined browsing server; and
URL indicating mail transmission means for transmitting an e-mail, to which the URL of the browsing server is added, to the mobile terminal together with any one of a portion of the e-mail having a predetermined data length, a portion of the e-mail having a capacity previously determined separately, and the summary of the contents of the text of the e-mail.

17. An e-mail transfer system according to claim 13 or 14, wherein
the transfer server apparatus comprises:
upload means for uploading, when an e-mail to be transferred includes image data, the e-mail to a predetermined browsing server: and URL indicating mail transmission means for transmitting an e-mail, to which the URL of the browsing server is added, to the mobile terminal together with an image whose size is reduced to a predetermined image size or less.

18. An e-mail transfer system according to claim 13, characterized in that
the transfer server apparatus comprises:
upload means for uploading not-transferred e-mails, which are not transferred in response to the designated information, to a predetermined browsing server when the not-transferred e-mails exceed a predetermined number,
wherein the mail transfer means transmits a summary mail, in which at least any ones of the themes of the not-transferred e-mails, at least parts of the texts thereof, and the summaries of the texts thereof are described as a list to which the URL of the not-transferred e-mails on the browsing server is added, to the mobile terminal.

19. An e-mail transfer system according to claim 8, wherein
the designated information, which is received from any one of a plurality of mobile terminals acting as subjects to which an e-mail is transferred, is also used in the other mobile terminals as designated information in the transfer server apparatus.
